(19) United States
(12) Patent Application Publication
(10) Pub. No.: US 2008/0083207 A1
(43) Pub. Date: Apr. 10, 2008

(54) Mower sickle bar

(75) Inventor: Reinhard Jordan, Purgstall (AT)

Correspondence Address: K.F. ROSS P.C., 5683 RIVERDALE AVENUE, SUITE 203 BOX 900, BRONX, NY, 10471-0900, US

(73) Assignee: BUSATIS GmbH

(21) Appl. No.: 11/906,762

(22) Filed: Oct. 3, 2007

(30) Foreign Application Priority Data
Oct. 10, 2006 (GM) 7392006

(51) Int. Cl. A01D 34/13; C21D 1/00

(52) U.S. Cl. 56/299; 148/714

(57) ABSTRACT

A mower sickle bar has an elongated metal bar having a longitudinally extending edge region that is tempered and thereadjacent a longitudinally extending middle region that is not tempered. The untempered middle region is formed with a row of throughgoing holes. A longitudinally extending row of blades lying on the metal bar at least partially over the untempered middle region thereof is secured thereto by fasteners projecting through the holes and through the blades.

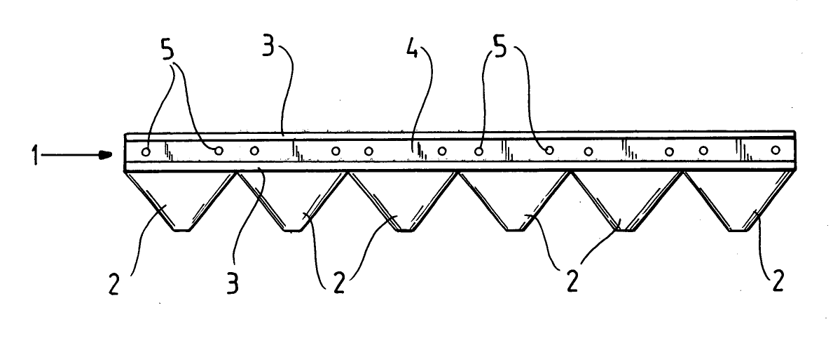

### FIELD OF THE INVENTION

The present invention relates to sickle-bar mower. More particularly this invention concerns a blade bar for such a mower and a method of making it.

### BACKGROUND OF THE INVENTION

A standard sickle-bar mower has a blade bar that is reciprocated relative to a holder bar. The blade bar carries a row of triangular sharp-edge blades, and the holder bar simply has a plurality of holding fingers formed with slots through which the blades move. Vegetation is trapped between the holding fingers and the blades and cut. Such an apparatus is extremely useful for mowing vegetation in difficult locations, as the bar can move under fences and around obstacles easily. It is also useful when the vegetation being cut does not need to be comminuted, as is done for example by a rotary mower. Thus for harvesting standing crops the sickle bar is used since it can cut the crop at the base without damaging or even touching the desired upper part carrying the corn, seed, or other commodity to be recovered.

Thus the typical sickle bar is an elongated metal bar formed at one end with an attachment location for securing to a power takeoff arm or the like and a row of throughgoing holes to which the individual blades are riveted or bolted. The blades are attached to the top side of the bar.

The known sickle bars are typically manufactured from untempered flat steel having a rectangular cross section and dimensions between 19×5 mm and 22×6 mm. The blade-attachment holes are circular and have a diameter of approximately 5.5 to 6.5 mm, and are generally punched by a tool.

In modern combines having large cutting widths, mower cutters are used which are actuated from one end and have lengths greater than 10 m and masses greater than 25 kg. Due to the high cutting frequency of 500 to 600 double strokes per minute, at 1000 to 1200 load alternations per minute the sickle bar is subjected to extremely high mechanical stress. In addition to the inertial forces from the acceleration and deceleration of the oscillating masses, the cutting forces must also be transmitted through the bar.

Due to this continuously high load state, fractures in the cutter bar may occur, the fracture sites most commonly being located at the drive end and in regions of reduced cross section resulting from the holes used for attaching the blades. To avoid these blade fractures, various attempts have been made to increase the strength of the bar material.

One approach for increasing the strength involves the use of higher-strength starting materials, or providing a tempering step before punching. The disadvantage of this approach is that the punching tool is subjected to high stress and rapid wear.

To protect the punching tool, it would be more advantageous to perform the tempering after the punching process. However, this approach has the disadvantage that the tempering causes a slight change in bar length and thus results in the blade-mounting holes being incorrectly spaced. The blades themselves are invariably made of hardened steel so that there is no way to accommodate a misalignment or misfit.

### OBJECTS OF THE INVENTION

It is therefore an object of the present invention to provide an improved mower sickle bar.

Another object is the provision of such an improved mower sickle bar that overcomes the above-given disadvantages, in particular that is very strong while at the same time being inexpensive to manufacture.

A further object is to provide an improved method of making such a sickle bar.

### SUMMARY OF THE INVENTION

A mower sickle bar has according to the invention an elongated metal bar having a longitudinally extending edge region that is tempered and thereadjacent a longitudinally extending middle region that is not tempered. The untempered middle region is formed with a row of throughgoing holes. A longitudinally extending row of blades lying on the metal bar at least partially over the untempered middle region thereof is secured thereto by fasteners projecting through the holes and through the blades.

Such a sickle bar according to the invention thus combines increased strength and improved wear resistance in the region of the tempered edge regions with the advantage that holes may be provided in the untempered middle region for attaching the mower cutter blades. Making the holes does not involve increased stress on the punching tool, and the holes do not change spacing during subsequent tempering of the edge regions.

In one preferred embodiment, both edge regions of the sickle bar extending in the longitudinal direction are tempered.

Furthermore according to the invention the mower bar is manufactured from rolled or drawn flat steel. The tempered edge regions preferably have a hardness of at least 30 HRC.

According to a further feature of the invention, the edge regions are inductively hardened.

In the method according to the invention for manufacturing a mower sickle bar a middle region is formed with holes, preferably by punching. The row of holes extends longitudinally. Before or after the holes are produced the sickle bar is tempered along at least one longitudinally extending edge region. After tempering, the holes may be punched in the untempered middle strip without subjecting the punching tool to additional stress. Tempering the edge regions after the punching does not result in changes in the length of the middle strip.

It is a further feature of the method that the edge regions are inductively hardened. The metal bar can also be tempered using the plunging process.

It may also be advantageous to vary the hardness of the edge regions in the longitudinal direction. The tempered edge regions may also extend over only one or more partial sections of the cutter bar.

In addition according to the invention, the width, i.e. the dimension perpendicular to the longitudinal direction, of the untempered middle region is equal to or greater than the dimension of a hole in this direction.

### BRIEF DESCRIPTION OF THE DRAWING

The above and other objects, features, and advantages will become more readily apparent from the following description, reference being made to the accompanying drawing whose sole FIGURE is s top view of a sickle bar according to the invention.

### SPECIFIC DESCRIPTION

As seen in the drawing a sickle bar 1 has a middle region 4 formed with holes by means of which individual mower cutter blades 2 are attached by fasteners 5, here rivets. The middle region 4 is untempered and is flanked by a pair of tempered regions 3.

The sickle bar 1 thus obtained has a much higher strength than sickle bars used heretofore, and at the same time punching tools for making the holes 5 are not subjected to greater than normal stress. It is not important whether the tempering step is performed before or after punching of the holes 5. When the edge regions 3 are tempered before the holes 5 are punched, this makes no difference for the punching, since the middle region 4 remains untempered. If the tempering is done after the holes are punched, there are no significant changes in the distances between the punched holes in the middle region 4.

I claim:

1. A mower sickle bar comprising:
an elongated metal bar having a longitudinally extending edge region that is tempered and thereadjacent a longitudinally extending middle region that is not tempered, the untempered middle region being formed with a row of throughgoing holes;
a longitudinally extending row of blades lying on the metal bar at least partially over the untempered middle region thereof; and
fasteners projecting through the holes and through the blades and thereby securing the blades to the bar.

2. The mower sickle bar defined in claim 1 wherein the bar has two such longitudinally extending edges regions that are temperate flanking the untempered middle region.

3. The mower sickle bar defined in claim 1 wherein the metal bar is of rolled or drawn flat steel.

4. The mower sickle bar defined in claim 1 wherein the tempered edge region has a hardness of at least 30 HRC.

5. The mower sickle bar defined in claim 1 wherein a hardness of the tempered edge region varies longitudinally along a length of the sickle bar.

6. The mower sickle bar defined in claim 1 wherein the tempered edge region is discontinuous.

7. The mower sickle bar defined in claim 1 wherein a transverse width of the untempered middle region is at least equal to a transverse width of the holes.

8. The mower sickle bar defined in claim 7 wherein the holes are circular and have diameters smaller than the width of the untempered middle region.

9. A method of making a mower sickle bar comprising the steps of:
tempering only a longitudinally extending edge region of a metal bar while leaving an adjacent longitudinally extending middle region of the metal bar untempered;
forming a row of attachment holes in the middle region; and
securing a row of blades to the bar by means of fasteners through the holes.

10. The method defined in claim 9 wherein the edge region is hardened inductively.

11. The method defined in claim 9 wherein the tempering is done by quench hardening.
